(19) United States
(12) Patent Application Publication
(10) Pub. No.: US 2003/0155882 A1
(43) Pub. Date: Aug. 21, 2003

(54) Anti-gravity mount with air and magnets

(75) Inventors: Kazuya Ono, Kumagaya-city (JP); Jean-Marc Gery, West Hollywood, CA (US)

Correspondence Address: BEYER WEAVER & THOMAS LLP, P.O. BOX 778, BERKELEY, CA, 94704-0778, US

(73) Assignee: Nikon Corporation, Tokyo (JP)

(21) Appl. No.: 10/079,291

(22) Filed: Feb. 19, 2002

(51) Int. Cl. B64C 17/06

(52) U.S. Cl. 318/649

(57) ABSTRACT

An apparatus for providing support between a first structure and a second structure is described. The apparatus includes a supporting member, and first and second sections. The supporting member is mounted to the first structure and second structure, and has positive stiffness with respect to a lateral direction. The first section has at least one magnetic member, and is coupled to the first structure. The second section has at least one magnetic member, and is coupled to the second structure. The first and second sections present negative stiffness caused by magnetic attractive force at a neutral position, thereby canceling at least a part of the positive stiffness of the supporting member.

### BACKGROUND OF THE INVENTION

The invention relates to a supporting mount, and specifically to methods and apparatus for supporting between a wafer table and a wafer stage used for semiconductor process.

Shock-absorbing mounts are widely used in a variety of applications. Above all, an optical apparatus used for semiconductor process requires high precision of imaging onto a target device. Springs have been used for damping of vibration transmitted from a wafer stage to a wafer table used for semiconductor manufacturing.

Current integrated circuit (IC) manufacturing practices use lithography photomasks (reticles) to apply various patterns to a photosensitized semiconductor wafer used to create the ICs. Reticles are typically high-precision plates that contain a pattern of extremely small images of the various components of an electronic circuit. A reticle is used as a master to transfer a plurality of the circuit pattern onto a photosensitized wafer. Current state-of-the-art lithographic system often must position an ultra-fine image to within 15 nanometers. Current circuit architectures often have conductor linewidths as narrow as 30 nanometers. Accordingly, lithography processing equipment requires advanced precision optical and mechanical systems and even higher precision systems will be required in the future, as still smaller images become common.

Lithographic exposure apparatuses are used to project images from the reticle onto the photosensitized wafer during semiconductor processing. A typical exposure apparatus includes a base frame having a lower enclosure that contains a wafer stage for holding a semiconductor wafer workpiece. The base frame also supports an optical device that holds a reticle stage and is arranged to project the images from a reticle carried by the reticle stage onto the wafer workpiece. The base frame typically supports the optical device through a vibration isolation system designed to damp and isolate vibrations between components of exposure apparatus so that vibrations in one component are not transmitted to the other.

This is deemed necessary because mechanical vibrations transmitted between components can adversely influence the accuracy of exposure apparatus. A potential problem with providing a spring between the wafer table and the wafer stage is that many if not most spring damper mechanisms provide high stiffness. In other words, the conventional damper mechanisms tend not to move flexibly (i.e., without stiffness) when the wafer stage is vibrated.

As such, it becomes increasingly necessary to devise a system that provides low stiffness between the wafer table and the wafer stage, thus avoiding transmission of vibration from the wafer stage to the wafer table.

### SUMMARY OF THE INVENTION

Various anti-gravity mounts according to the embodiments of the present invention include (i) a supporting member mounted to a wafer table and a wafer stage; and (ii) two sections, each of which contains a magnetic member. In one specific embodiment, the supporting member is a bellow which has an airtight, pressurized cavity. The two sections present negative stiffness caused by magnetic force (attractive force or repulsive force) therebetween, thereby canceling at least a part of positive stiffness of a bellow. Consequently, embodiments of the present invention provide low overall stiffness with respect to a direction that differs from a support direction of the apparatus. In a specific embodiment, the support direction is a vertical direction, and the direction along which the low overall stiffness is provided is a lateral direction. This low overall stiffness contributes to low transmissivity of vibration between a wafer table and a wafer stage.

In a specific embodiment, the two sections include a steel cylindrical shell and a permanent magnet core. The directions of magnetic poles of the steel cylindrical shell and the permanent magnet core are determined so that the two members present magnetic attractive force therebetween. Consequently, the two members provide negative stiffness along lateral directions, thereby canceling positive stiffness created by other mechanical structures. Thus, the embodiment of the present invention is capable of providing low overall stiffness, and thus, reducing vibration transmitted from the wafer stage to the wafer table.

In another specific embodiment, the steel cylindrical shell described above is divided into two cylindrical shells. The two cylindrical shells and the permanent magnet core of this specific embodiment also provide negative stiffness, and thus, reduce transmissivity of vibration between the wafer table and the wafer stage.

In still another specific embodiment, the two steel cylindrical shells have two cylindrical shell made from permanent magnet material. The two steel cylindrical shells, the two magnetic cylindrical shells, and the permanent magnet core of this embodiment provide negative stiffness, and thus, reduce transmissivity of vibration between the wafer table and the wafer stage.

In still another specific embodiment, a lithography system includes an illumination system that irradiates radiant energy, a positioning apparatus that disposes a substrate on a path of the radiant energy, and a system that provides support between a first structure and a second structure. The system includes a supporting member mounted to the first structure and second structure. The supporting member has positive stiffness with respect to a first direction. The system further includes a first section having at least one magnetic member and a second section having at least one magnetic member. The first and second sections are coupled to the first and second structures, respectively. The first and second sections present negative stiffness caused by magnetic force, thereby canceling at least a part of the positive stiffness of the supporting member.

A further understanding of the nature and advantages of the present invention may be realized by reference to the remaining portions of the specification and the drawings.

### BRIEF DESCRIPTION OF THE DRAWING

The invention, together with further objects and advantages thereof, may best be understood by reference to the following description taken in conjunction with the accompanying drawings in which:

FIG. 1 is a cross-sectional view of an exemplary lithographic exposure apparatus that incorporates the present invention.

FIG. 2 is a process flow diagram illustrating an exemplary process by which semiconductor devices are fabricated using the systems shown in FIG. 1 according to the present invention.

FIG. 3 is a flowchart of the wafer processing step shown in FIG. 2 in the case of fabricating semiconductor devices according to the present invention.

FIG. 4 is a cross-sectional view of an anti-gravity mount according to a specific embodiment of the present invention.

FIG. 5 is a perspective cross-sectional view of the anti-gravity mount shown in FIG. 4 according to a specific embodiment the present invention.

FIG. 6 is a perspective view of the bellow and the top and bottom flanges used for a specific embodiment of the present invention.

FIG. 7 is a perspective view of the header used for a specific embodiment of the present invention.

FIG. 8 is a perspective view of the cylindrical shell used for a specific embodiment of the present invention.

FIG. 9 is a perspective view of the bottom mount and the holes used for a specific embodiment of the present invention.

FIG. 10 is a perspective view of the cylindrical core used for a specific embodiment of the present invention.

FIG. 11 is a perspective view of the anti-gravity mount used for a specific embodiment of the present invention.

FIG. 12 is a cross-sectional view of an anti-gravity mount according to another embodiment of the present invention.

FIG. 13 is a perspective cross-sectional view of the anti-gravity mount shown in FIG. 12.

FIG. 14 is a cross-sectional view of an anti-gravity mount according to still another embodiment of the present invention.

FIG. 15 is a perspective cross-sectional view of the anti-gravity mount shown in FIG. 14.

FIG. 16 is a simplified cross-sectional view of an anti-gravity mount according to a specific embodiment of the present invention.

FIG. 17 is a simplified cross-sectional view of an anti-gravity mount according to another embodiment of the present invention.

FIG. 18 is a simplified cross-sectional view of an anti-gravity mount according to still another embodiment of the present invention.

FIG. 19 is a simplified cross-sectional view of an anti-gravity mount according to still another embodiment of the present invention.

FIG. 20 is a simplified cross-sectional view of an anti-gravity mount according to still another embodiment of the present invention.

FIG. 21 is a simplified cross-sectional view of an anti-gravity mount with a mover according to still another embodiment of the present invention.

### DETAILED DESCRIPTION OF SPECIFIC EMBODIMENTS

Various anti-gravity mounts according to the embodiments of the present invention include (i) a supporting member mounted to a wafer table and a wafer stage; and (ii) two sections, each of which contains a magnetic member. In one specific embodiment, the supporting member is a bellow that has an airtight, pressurized cavity. The two sections present negative stiffness caused by a magnetic force (an attractive force or a repulsive force) therebetween, thereby canceling at least a part of positive stiffness of the supporting member (e.g., a bellow). Consequently, embodiments of the present invention provide low overall stiffness with respect to a lateral direction, which contributes to low transmissivity of vibration between a wafer table and a wafer stage. Embodiments of the present invention will now be described in detail with reference to the drawings, wherein like elements are referred to with like reference labels throughout.

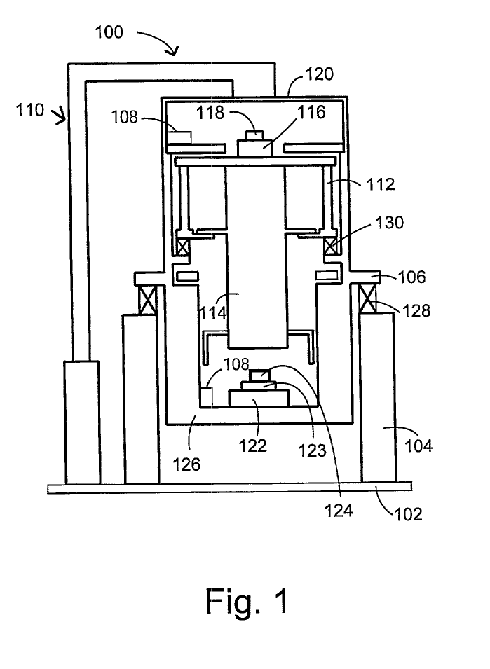

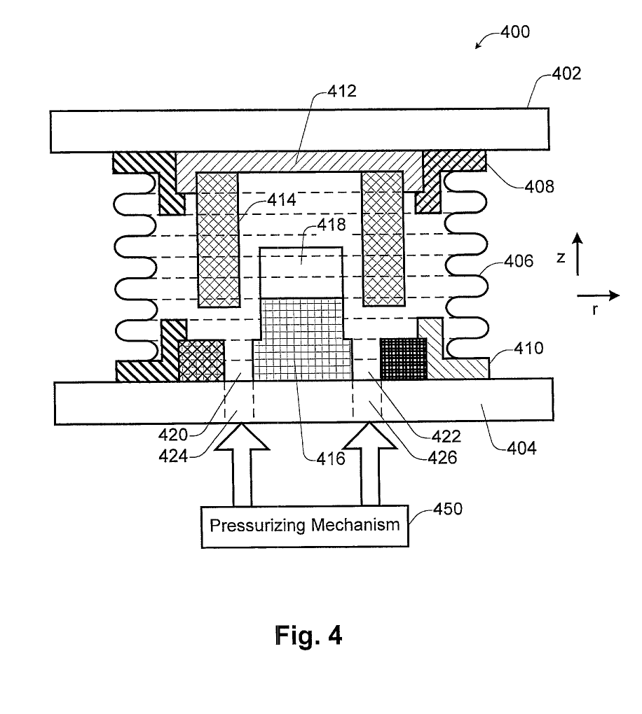

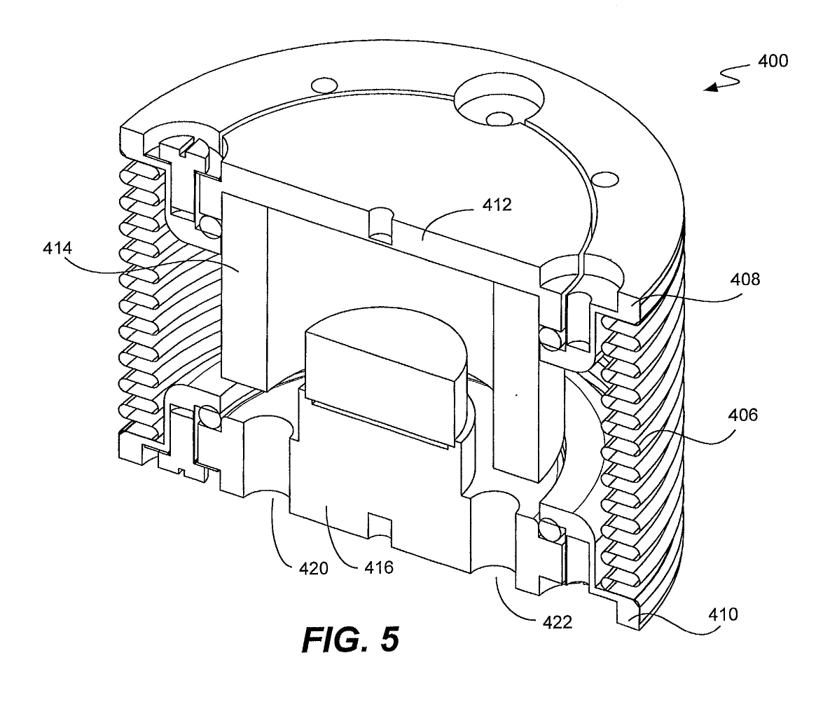

FIG. 4 is a cross-sectional view of an anti-gravity mount 400 according to a specific embodiment of the present invention. FIG. 5 is a perspective cross-sectional view of the anti-gravity mount 400. The anti-gravity mount 400 provides support between a wafer table 402 and a wafer stage 404 used for a lithographic exposure apparatus which will be described later referring to FIG. 1. In FIG. 4, arrows “z” and “r” indicate vertical and lateral directions, respectively.

A bellow 406 is mounted to the wafer table 402 and the wafer stage 404 at a top flange 408 and a bottom flange 410, respectively. The top and bottom flanges 408 and 410 of the bellow 406 are fixed to the wafer table 402 and the wafer stage 404, respectively, by screws or any other suitable linking methods. The bellow 406 is a flexible accordion film, which allows both vertical and lateral movement of the wafer table 402 with respect to the wafer stage 404, thereby preventing vibration from being transmitted from the wafer stage 404 to the wafer table 402. The bellow 406 is made from metallic materials including stainless steel, aluminum, and the like.

A header 412 is connected to the wafer table 402. A cylindrical shell 414 is connected to the header 412. In some embodiment, the cylindrical shell 414 is made from one of nonretentive soft magnetic materials including iron, iron-silicon alloys, iron-cobalt alloys, iron-aluminum alloys, iron-aluminum-silicon alloys, iron-nickel alloys, powder cores, ferrites, and the like. In this specific embodiment shown in FIGS. 4 and 5, the cylindrical shell 414 is made from magnetic steel with saturation flux density which is greater than 16,000 Gauss.

A bottom mount 416 is connected to the wafer stage 404. A cylindrical core 418 is connected to the bottom mount 416. In some embodiments, the cylindrical core 418 is made from one of retentive hard magnetic materials, which are characterized by a high-energy product, making them suitable for permanent magnets. These materials have high remanences and coercive forces, and include martensitic lattice-transformation alloys (quench- and work-hardened alloys), precipitation-hardened alloys, ordered alloys, fine-particle magnets, and the like. In this specific embodiment illustrated in FIGS. 4 and 5, the cylindrical core 418 is made from a permanent magnet material, e.g., NdFeB. The cylindrical core 418 may have a magnetic pole directing to upward or downward along the z direction in the figures.

The bottom mount 416 has holes 420 and 422. The wafer stage 404 has holes 424 and 426. The holes 420 and 424, and the holes 422 and 426 define passageways through which air within the bellow 406 is pressurized at the predetermined value by a pressurizing mechanism 450. The pressurized air within the bellow 406 is used for compensating the weight of the wafer table 402. Thus, the wafer table 402, the wafer stage 404, and the bellow 406 are sealed in an airtight manner.

In order to reduce vibration transmissivity between the wafer table 402 and the wafer stage 404, the anti-gravity mount 400 as a whole preferably presents low stiffness. Table 1 below shows quantitative characteristics of components included in the anti-gravity mount 400.

TABLE 1

| Element | F | Kz | Kr |
|---|---|---|---|
| Pressurized Air | ++ | + | 0 |
| Bellow | 0 | + | + |
| Magnetic Members | 0 | + or − | − |

The terms “F,” “Kz,” and “Kr” designate static force along a vertical direction, stiffness along a vertical direction, and stiffness along a lateral direction, respectively. Here, the cylindrical shell 414 and the cylindrical core 418 are generally referred to as “magnetic members.”

The pressurized air within the bellow 406 functions as a support for the weight of the wafer table 402 (F=++). Thus, even though the bellow 406 itself and the magnetic members do not provide any force to support the weight of the wafer table 402 (F=0), the anti-gravity mount 400 can compensate the weight of the wafer table 402 by pressurized air within the bellow 406. In this specification, a “neutral position” is a position in which the wafer table 402 is located in a stable state without any transient disturbance.

Both the air within the bellow 406 and the bellow 406 itself have vertical stiffness which is positive (Kz=+). In this specification, the stiffness is “positive” when a point receives a repulsive force in an opposite direction to a direction along which the point is about to move. Similarly, in this specification, the stiffness is “negative” when a point receives an attractive force in a direction along which the point is about to move. Magnetic members present positive or negative stiffness Kz along a vertical direction depending on a structural and magnetic characteristics of the magnetic members.

The pressurized air within the bellow 406 has lateral stiffness which is about zero (Kr=0), and the bellow 406 itself has positive lateral stiffness (Kr=+). In various embodiments of the present invention, the magnetic members (i.e., the cylindrical shell 414 and the cylindrical core 418) have negative lateral stiffness (Kr=−) since the magnetic members causes magnetic attractive force therebetween. Therefore, the embodiments of the present invention are capable of canceling at least a part of the positive stiffness of the bellow 406. As a result, anti-gravity mounts according to the embodiments of the present invention have low overall stiffness with respect to lateral directions, thereby reducing vibration transmissivity between the wafer table 402 and the wafer stage 404.

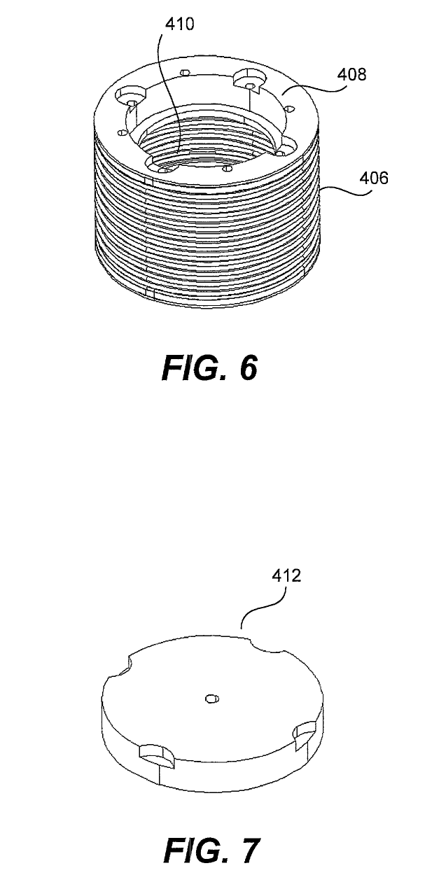

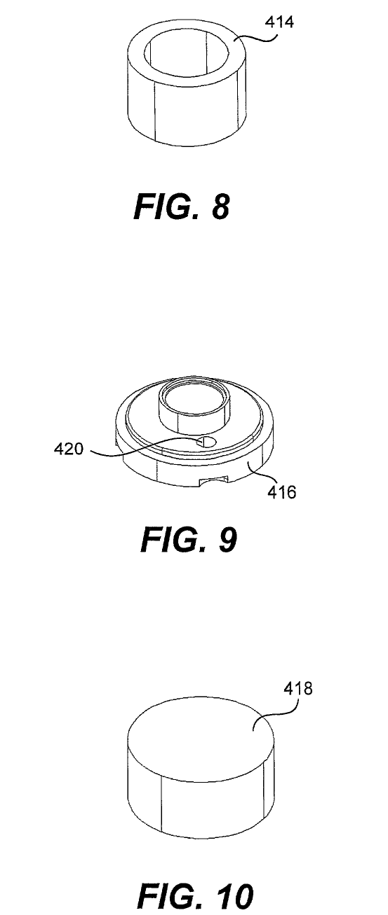

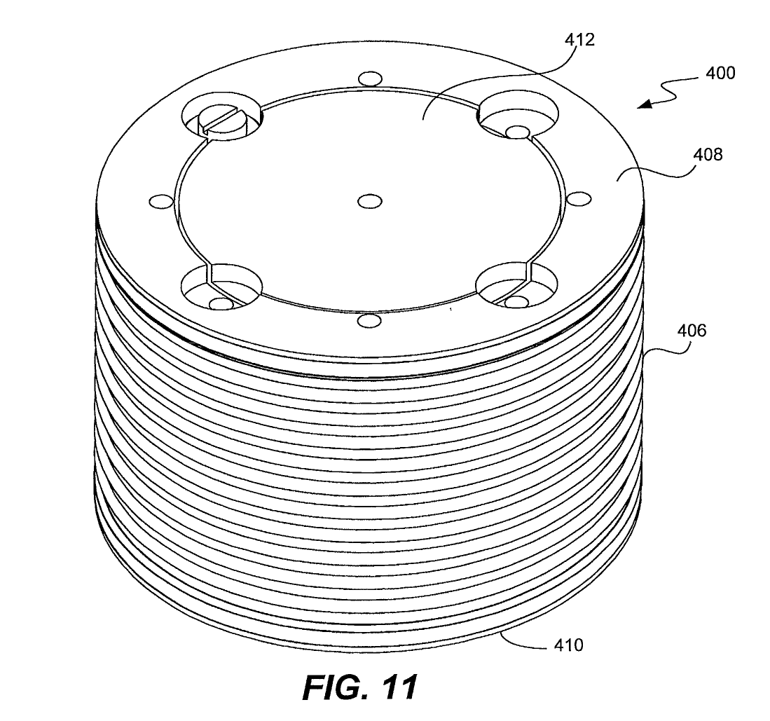

FIG. 6 is a perspective view of the bellow 406 and the top and bottom flanges 408 and 410. FIGS. 7 and 8 are perspective views of the header 412 and the cylindrical shell 414, respectively. FIG. 9 is a perspective view of the bottom mount 416 and the holes 420 and 422 (not shown). FIG. 10 is a perspective view of the cylindrical core 418. FIG. 11 is a perspective view of the anti-gravity mount 400.

In the above-described embodiment, the cylindrical core 418 is provided within the cylindrical shell 414. In this specification, the cylindrical core 418 is provided “within” the cylindrical shell 414 as long as the cylindrical core 418 is located within an infinite cylindrical surface defined by the inner surface of the cylindrical shell 414. Thus, for example, even when the bottom edge of the cylindrical core 418 is located below the bottom edge of the cylindrical shell 414 in FIG. 4, the cylindrical core 418 is “within” the cylindrical shell 414.

In the above-described embodiment, the cylindrical shell 414 is made from one of nonretentive soft magnetic materials, and the cylindrical core 418 is made from one of retentive hard magnetic materials. However, it should be appreciated that both the cylindrical shell 414 and the cylindrical core 418 may be made from one of retentive hard magnetic materials described above. Alternatively, the cylindrical shell 414 may be made of a retentive magnetic material and the cylindrical core 418 may be made of a nonretentive magnetic material. In these cases, the cylindrical shell 414 may have a magnetic pole directing to upward or downward along the z direction in the figures.

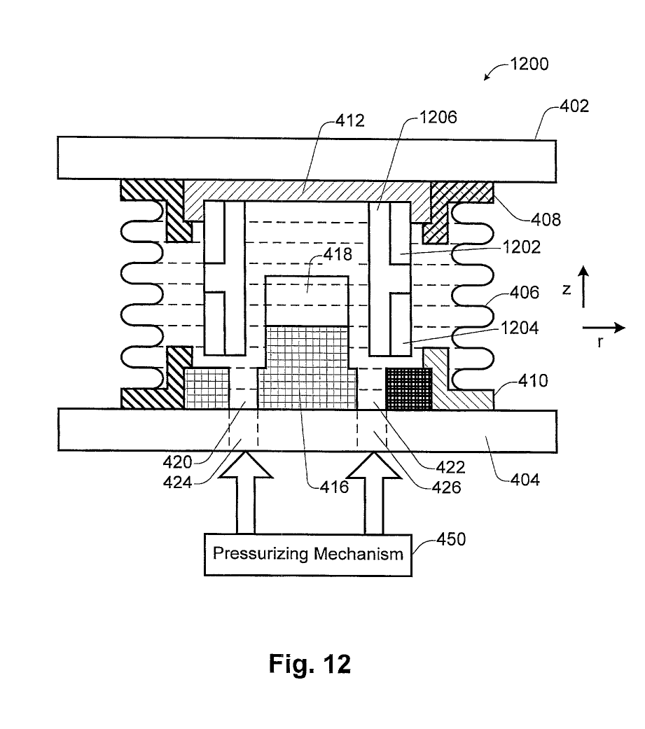

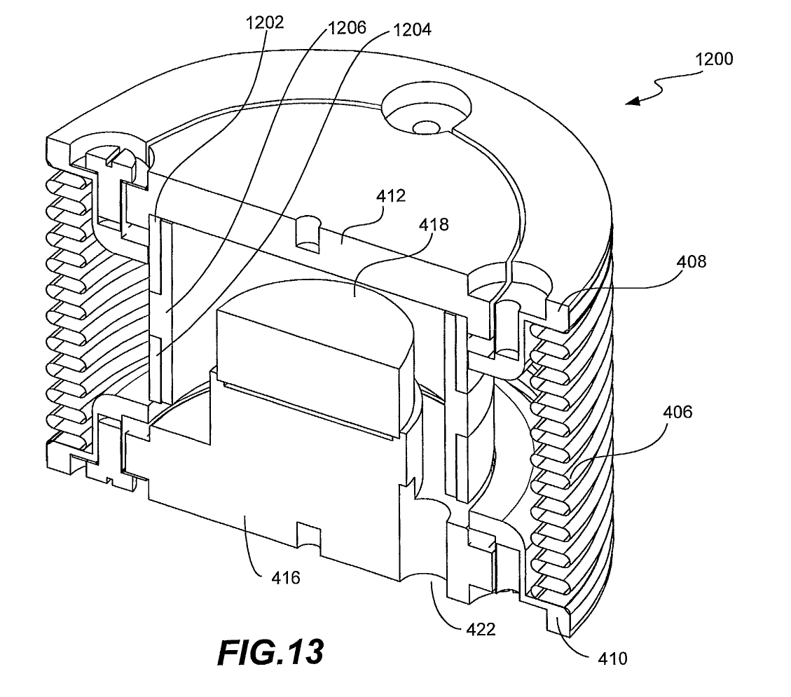

FIG. 12 is a cross-sectional view of an anti-gravity mount 1200 according to a specific embodiment of the present invention. FIG. 13 is a perspective cross-sectional view of the anti-gravity mount 1200. The anti-gravity mount 1200 is shown in FIGS. 12 and 13, in which components that are indicated to corresponding components shown in FIGS. 4 and 5 have the same respective reference numerals.

In this specific embodiment illustrated in FIGS. 12 and 13, two cylindrical shells 1202 and 1204 and a separator 1206 are utilized instead of the cylindrical shell 414. The cylindrical shells 1202 and 1204 are made from one of nonretentive soft magnetic materials including iron, iron-silicon alloys, iron-cobalt alloys, iron-aluminum alloys, iron-aluminum-silicon alloys, iron-nickel alloys, powder cores, ferrites, and the like. In this specific embodiment shown in FIGS. 12 and 13, the cylindrical shells 1202 and 1204 are made from magnetic steel with saturation flux density which is greater than 16,000 Gauss. The separator 1206 is made from one of non-magnetic materials including plastic, resin, and the like. As in the first embodiment, the cylindrical core 418 may have a magnetic pole directing to upward or downward along the z direction of in the figures.

In this embodiment, the stiffness of the anti-gravity mount 1200 in the z direction can be set to a desired value by adjusting the strength of a first magnetic field (magnetic force) generated by the cylindrical core 418 and the cylindrical shell 1202 and a second magnetic field (magnetic force) generated by the cylindrical core 418 and the cylindrical shell 1204.

In the above-described embodiment, the cylindrical shells 1202 and 1204 are made from one of nonretentive soft magnetic materials, and the cylindrical core 418 is made from one of retentive hard magnetic materials. However, it should be appreciated that at least one of the cylindrical shells 1202 and 1204 and the cylindrical core 418 may be made from one of retentive hard magnetic materials described above. As in the first embodiment, the cylindrical core 418 may have a magnetic pole directing to upward or downward along the z direction of in the figures.

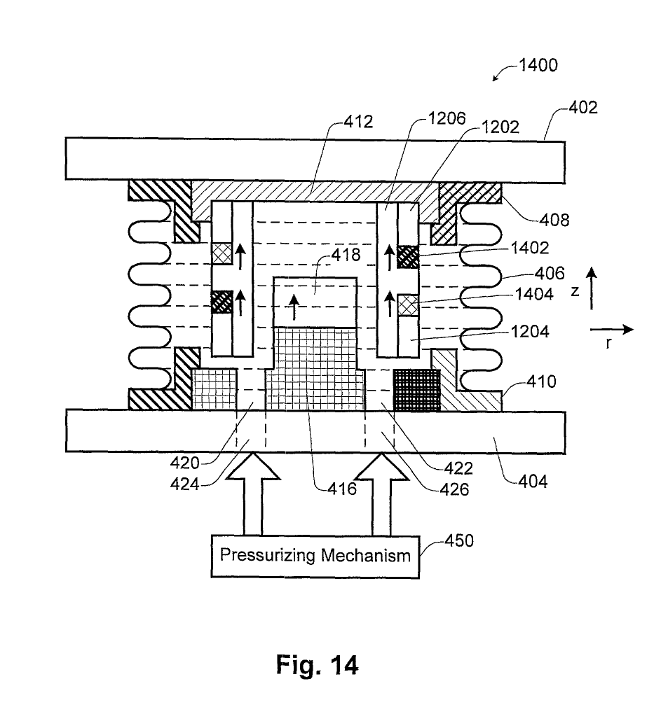

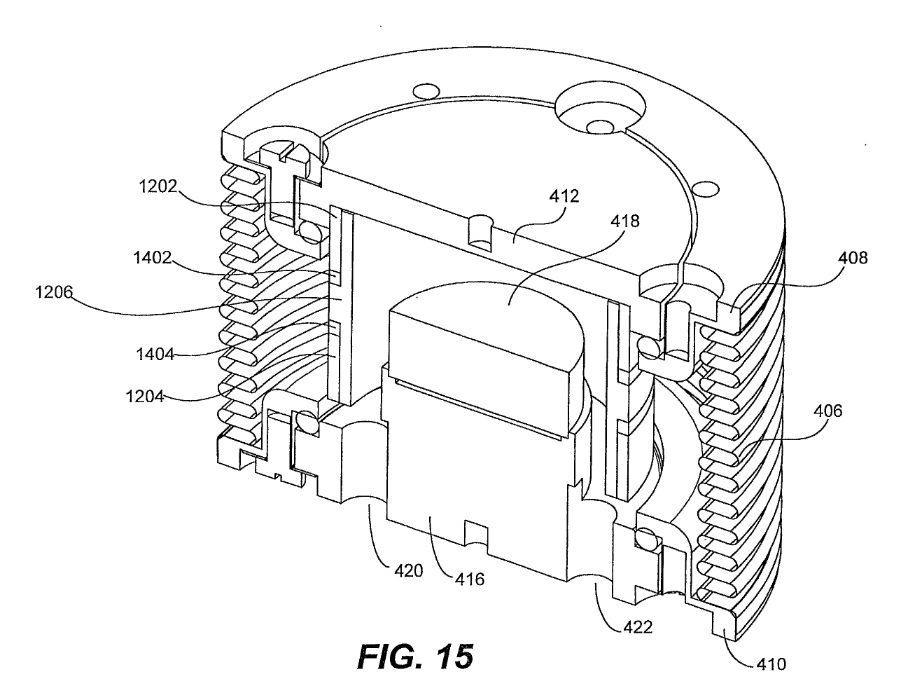

FIG. 14 is a cross-sectional view of an anti-gravity mount 1400 according to a specific embodiment of the present invention. FIG. 15 is a perspective cross-sectional view of the anti-gravity mount 1400. The anti-gravity mount 1400 is shown in FIGS. 14 and 15, in which components that are indicated to corresponding components shown in FIGS. 12 and 13 have the same respective reference numerals.

In this specific embodiment illustrated in FIGS. 14 and 15, the cylindrical shells 1202 and 1204, and the separator 1206 sandwich two separate magnetic cylindrical shells 1402, 1404, and the cylindrical core 418, respectively. The magnetic cylindrical shells 1402 and 1404 are made from one of retentive hard magnetic materials described above. The cylindrical shells 1202 and 1204 are made from one of nonretentive soft magnetic materials described above. The arrows indicated near the cylindrical core 418 and the magnetic cylindrical shells 1402 and 1404 represent a direction of magnetic poles. Thus, the directions of magnetic poles of the cylindrical core 418 and the magnetic cylindrical shells 1402 and 1404 are the same in this specific embodiment. In this specification, arrows indicated near permanent magnets or retentive hard magnetic materials represent a direction of magnetic poles (from S to N). Similar to the second embodiment shown in FIGS. 12 and 13, the stiffness of the anti-gravity mount 1400 in the z direction can be set desired value by adjusting the strength of a first magnetic field (magnetic force) generated by the cylindrical core 418, the cylindrical shell 1202, and the separate magnetic cylindrical shell 1402 and a second magnetic field (magnetic force) generated by the cylindrical core 418, the cylindrical shell 1204, and the separate magnetic cylindrical shell 1404.

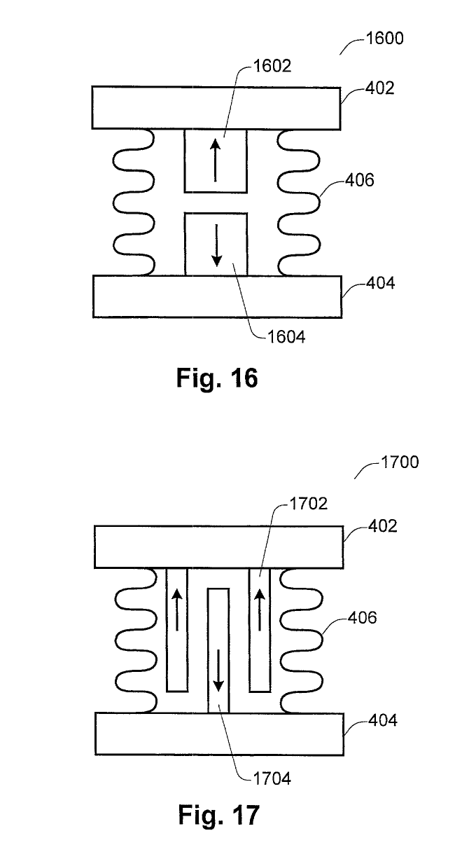

FIG. 16 is a simplified cross-sectional view of an anti-gravity mount 1600 according to a specific embodiment of the present invention. In the following description of the embodiments of the present invention referring to FIGS. 16-19, omitted elements such as the flanges 408 and 410, the header 412, the bottom mount 416, the pressurizing mechanism 450, the separator 1206, and the like may be adequately utilized in practicing the invention if necessary.

The anti-gravity mount 1600 includes two permanent magnets 1602 and 1604 made from one of retentive hard magnetic materials described above. The magnets 1602 and 1604 are, for example, in a cylindrical shape. In the anti-gravity mount 1600, the magnets 1602 and 1604 face with each other at an end thereof at the neutral position. Since the magnetic pole directions of the permanent magnets 1602 and 1604 are opposite, the magnets 1602 and 1604 generate repulsive force at the ends of the magnets 1602 and 1604, and thus, present negative stiffness along lateral directions. As a result, the magnets 1602 and 1604 cancel at least a part of the positive stiffness of the bellow 406, thereby reducing transmissivity of vibration between the wafer table 402 and the wafer stage 404.

FIG. 17 is a simplified cross-sectional view of an anti-gravity mount 1700 according to a specific embodiment of the present invention.

The anti-gravity mount 1700 includes two permanent magnets 1702 and 1704 made from one of retentive hard magnetic materials described above. The magnet 1702 is, for example, in a cylindrical shell shape. The magnet 1704 is, for example, in a cylindrical core shape. In the anti-gravity mount 1700, the magnet 1704 is provided within the magnet 1702 at the neutral position. Since the magnetic pole directions of the permanent magnets 1702 and 1704 are opposite, the magnets 1702 and 1704 generate attractive force at the ends of the magnets 1702 and 1704, and thus, present negative stiffness along lateral directions. As a result, the magnets 1702 and 1704 cancel at least a part of the positive stiffness of the bellow 406, thereby reducing transmissivity of vibration between the wafer table 402 and the wafer stage 404.

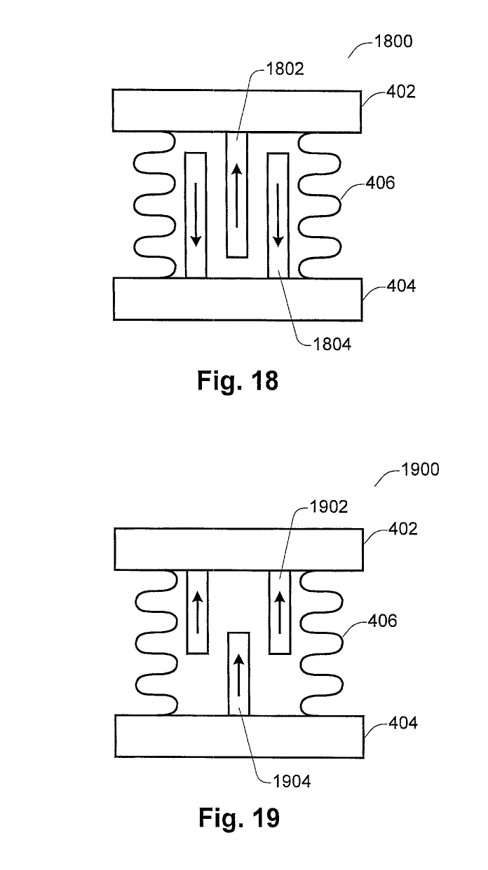

FIG. 18 is a simplified cross-sectional view of an anti-gravity mount 1800 according to a specific embodiment of the present invention.

The anti-gravity mount 1800 includes two permanent magnets 1802 and 1804 made from one of retentive hard magnetic materials described above. The magnet 1804 is, for example, in a cylindrical shell shape. The magnet 1802 is, for example, in a cylindrical core shape. In the anti-gravity mount 1800, the magnet 1802 is provided within the magnet 1804 at the neutral position. Those skilled in the art would recognize that a cylindrical core magnet can be attached to the wafer table 402 rather than the wafer stage 404. Since the magnetic pole directions of the permanent magnets 1802 and 1804 are opposite, the magnets 1802 and 1804 generate attractive force at the ends of the magnets 1802 and 1804, and thus, present negative stiffness along lateral directions. As a result, the magnets 1802 and 1804 cancel at least a part of the positive stiffness of the bellow 406, thereby reducing transmissivity of vibration between the wafer table 402 and the wafer stage 404.

FIG. 19 is a simplified cross-sectional view of an anti-gravity mount 1900 according to a specific embodiment of the present invention.

The anti-gravity mount 1900 includes two permanent magnets 1902 and 1904 made from one of retentive hard magnetic materials described above. The magnet 1902 is, for example, in a cylindrical shell shape. The magnet 1904 is, for example, in a cylindrical core shape. In the anti-gravity mount 1900, the magnet 1904 is provided within the magnet 1902 at the neutral position. Since the magnetic pole directions of the permanent magnets 1902 and 1904 are the same in this specific embodiment, the magnets 1902 and 1904 generate attractive force at the ends of the magnets 1902 and 1904, and thus, present negative stiffness along lateral directions. Those skilled in the art would recognize that the permanent magnets 1902 and 1904 have less overlapped portion relative to those shown in FIG. 17. Therefore, in this embodiment, the magnets 1902 and 1904 present negative stiffness by reversing the magnetic pole direction of the magnet 1704 which corresponds to the magnet 1904. As a result, the magnets 1902 and 1904 cancel at least a part of the positive stiffness of the bellow 406, thereby reducing transmissivity of vibration between the wafer table 402 and the wafer stage 404.

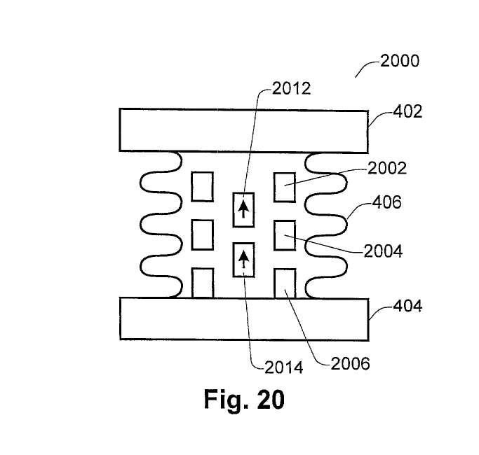

FIG. 20 is a simplified cross-sectional view of an anti-gravity mount according to still another embodiment of the present invention.

The anti-gravity mount 2000 includes two permanent magnets 2012 and 2014 which are attached to the wafer table 402 and made from one of retentive hard magnetic materials described above, and cylindrical shells 2002, 2004 and 2006 which are attached to the wafer stage 404 and made from one of non-retentive soft magnetic materials described above. The magnets 2012 and 2014 are, for example, in a cylindrical core shape. In the anti-gravity mount 2000, the magnets 2012 and 2014 are provided within the cylindrical shells 2002, 2004 and 2006. The magnets 2012 and 2014, and the cylindrical shells 2002, 2004 and 2006 generate attractive force, and thus, present negative stiffness along lateral directions. As a result, the magnets 1902 and 1904 cancel at least a part of the positive stiffness of the bellow 406, thereby reducing transmissivity of vibration between the wafer table 402 and the wafer stage 404. Since a plurality of magnets and a plurality of steel cylindrical shells are utilized, this specific embodiment provides higher linearity of stiffness, and thus, provides stable characteristics with respect to a wider range of movement of the wafer table 402.

As described above, the various embodiments of the present invention include at least one magnetic member made from a retentive hard magnetic material so that the outer cylindrical shell (e.g., 414) and the inner cylindrical core (e.g., 418) generate magnetic force (attractive force or repulsive force), and thus, present negative stiffness. Accordingly, in some embodiments, the outer cylindrical shell may be made from one of the retentive hard materials, and the inner cylindrical core may be made from one of the non-retentive soft materials. Permanent magnets utilized for the embodiments described above may be replaced by electromagnets.

In the above-described embodiments, the airtight cavity within the bellow 406 may be depressurized depending on the stiffness of the bellow 406. For example, if the bellow 406 has a relatively large stiffness and the level of the wafer table 402 along the vertical direction is higher than the suitable level, the cavity within the bellow 406 may be depressurized, i.e., given lower pressure than the atmospheric pressure outside the bellow 406 so that the wafer table 402 can be lowered by the negative pressure within the bellow 406.

Referring next to FIG. 1, one exemplary lithographic exposure that incorporates the present invention will be briefly described. A typical exposure apparatus 100 includes a mounting base 102, a support frame 104, a base frame 106, a measurement system 108, a control system (not shown), an illumination system 110, an optical frame 112, an optical device 114, a reticle stage 116 for retaining a reticle 118, an upper enclosure 120 surrounding reticle stage 116, a wafer stage 122, a wafer table 123 for retaining a semiconductor wafer workpiece 124, and a lower enclosure 126 surrounding wafer stage 122.

The support frame 104 typically supports base frame 106 above mounting base 102 through a base vibration isolation system 128. Base frame 106 in turn supports, through an optical vibration isolation system 130, optical frame 112, measurement system 108, reticle stage 116, upper enclosure 120, optical device 114, wafer stage 122, wafer table 123, and lower enclosure 126 above base frame 106. Optical frame 112 in turn supports optical devise 114 and reticle stage 116 above base frame 106 through optical vibration isolation system 130. As a result thereof, optical frame 112 and its supported components and base frame 106 are effectively attached in series through base vibration isolation system 128 and optical vibration isolation system 130 to mounting base 102. Vibration isolation systems 128 and 130 are designed to damp and isolate vibrations between components of exposure apparatus 100. Measurement system 108 monitors the positions of stages 116 and 122 relative to a reference such as optical device 114 and outputs position data to the control system. Optical device 114 typically includes a lens assembly that projects and/or focuses the light or beam from an illumination system 110 that passes through reticle 118. Reticle stage 116 is attached to one or more movers (not shown) directed by the control system to precisely position reticle 118 relative to optical device 114. Similarly, wafer stage 122 includes one or more movers (not shown) to precisely position the wafer workpiece 124 with wafer table 123 relative to optical device (lens assembly) 114.

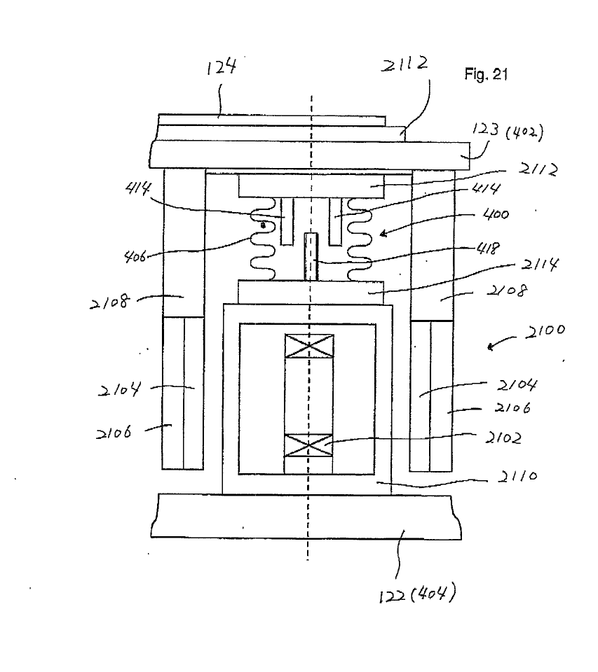

FIG. 21 is a simplified cross-sectional view of an anti-gravity mount with a mover. A wafer table 123 moves relative to wafer stage 122 by the mover (for example, electromagnetic actuator utilizing Lorentz type force) for leveling and focusing motions of wafer workpiece 124. The actuator may include a plurality of actuators disposed between wafer stage 122 and wafer table 123 so that wafer table 123 can move relative to wafer stage 122 in six degrees of freedom (X, Y, Z, θx, θy, θz). In this case, the anti-gravity system and the actuator that generates driving force in the z direction can be mounted between wafer stage 122 and wafer table 123 coaxially as shown in FIG. 21. FIG. 21 indicates a Z-mount structure including the anti-gravity mount 400 shown in FIGS. 4-11 (only main elements are shown) and a voice coil motor (VCM) 2100 as one specific example of electromagnetic actuators.

The voice coil motor 2100 includes at least one “coil” (or, an electromagnet having conductor) 2102, a coil holder 2110 that is connected to the wafer stage 122 (404) and holds the coil 2102, a pair of magnets 2104 facing the coil 2102 via air gaps and the coil holder 2110, a yoke member 2106 that holds the magnets 2104, and a yoke holder 2108 that is connected to the wafer table 123 (402). The coil 2102 is held in a chamber of the coil holder 2110 and cooled by coolant in the chamber. The anti-gravity mount 400 provides support between the wafer stage 122 (404) and the wafer table 123 (402). The bellow 406 is mounted to the wafer stage 122 and the wafer table 123 at a top base 2112 and a bottom base 2114, respectively. The top base 2112 is fixed to the wafer table 123. The bottom base 2114 is fixed to the coil holder 2110 of the voice coil motor 2100. The cylindrical core 418 is mounted to the bottom base 2114. The cylindrical shell 414 is mounted to the top base 2112.

Electric current (not shown) is supplied to the coil 2102 by the control system (not shown). The electric current in the coil 2102 interacts with the magnetic fields generated by the magnets 2104. This causes an electromagnetic force (a Lorentz type force) between the coil 2102 and the magnets 2104 that can be used to move the wafer table 123 relative to the wafer stage 122 in the z direction.

In the case of the Z-mount structure shown in FIG. 21, similar to one described in U.S. Pat. No. 5,701,041, the entirety of which is incorporated herein by reference for all purposes, the anti-gravity mount 400 and the voice coil motor 2100 are arranged so that the axis of the driving force of the voice coil motor 2100 and the axis of a support force generated by the anti-gravity mount 400 coincide with each other substantially.

Further, by providing a plurality of (at least three) Z-mount structures and adjusting value of a force caused by each Z-mount structure, the wafer table 123 moves relative to the wafer stage 122 in the θx and θy directions respectively in addition to the z direction.

The wafer stage 122 and the wafer table 123 may have a shielding member that shields magnetic fields generated by the magnetic materials of the anti-gravity mount 400 so that the magnetic fields do not adversely affect the devices mounted around the wafer stage 122 and the wafer table 123.

This embodiment of the present invention may be utilized for reticle stage 116 in addition to wafer stage 122 by providing a reticle table that retains reticle 118 and moves relative to stage 116.

As will be appreciated by those skilled in the art, there are a number of different types of photolithographic devices. For example, exposure apparatus 100 can be used as a scanning type photolithography system which exposes the pattern from reticle 118 onto wafer 124 with reticle 118 and wafer 124 moving synchronously. In a scanning type lithographic device, reticle 118 is moved perpendicular to an optical axis of optical device 114 by reticle stage 116 and wafer 124 is moved perpendicular to an optical axis of optical device 114 by wafer stage 122. Scanning of reticle 118 and wafer 124 occurs while reticle 118 and wafer 124 are moving synchronously.

Alternately, exposure apparatus 100 can be a step-and-repeat type photolithography system that exposes reticle 118 while reticle 118 and wafer 124 are stationary. In the step and repeat process, wafer 124 is in a constant position relative to reticle 118 and optical device 114 during the exposure of an individual field. Subsequently, between consecutive exposure steps, wafer 124 is consecutively moved by wafer stage 122 perpendicular to the optical axis of optical device 114 so that the next field of semiconductor wafer 124 is brought into position relative to optical device 114 and reticle 118 for exposure. Following this process, the images on reticle 118 are sequentially exposed onto the fields of wafer 124 so that the next field of semiconductor wafer 124 is brought into position relative to optical device 114 and reticle 118.

However, the use of exposure apparatus 100 provided herein is not limited to a photolithography system for a semiconductor manufacturing. Exposure apparatus 100, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines. The present invention is desirable in machines where it is desirable to prevent the transmission of vibrations.

The illumination source (of illumination system 110) can be g-line (436 nm), i-line (365 nm), KrF excimer laser (248 nm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆,) or tantalum (Ta) can be used as an electron gun. Furthermore, in the case where an electron beam is used, the structure could be such that either a mask is used or a pattern can be directly formed on a substrate without the use of a mask.

With respect to optical device 114, when far ultra-violet rays such as the excimer laser is used, glass materials such as quartz and fluorite that transmit far ultra-violet rays is preferably used. When the F₂ type laser or x-ray is used, optical device 114 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above mentioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

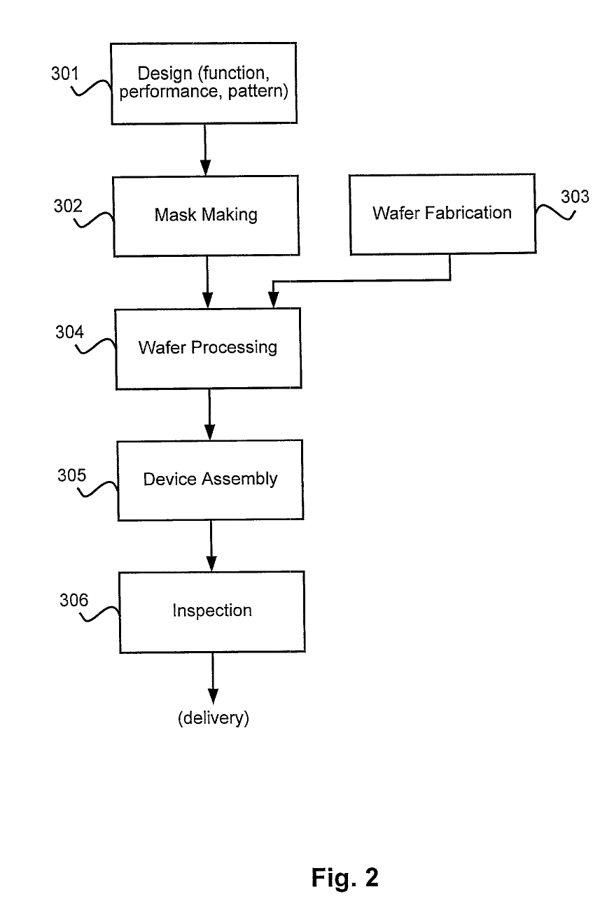

Further, semiconductor devices can be fabricated using the above described systems, by the process shown generally in FIG. 2. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system such as the systems described above. In step 305 the semiconductor device is assembled (including the dicing process, bonding process and packaging process), then finally the device is inspected in step 306.

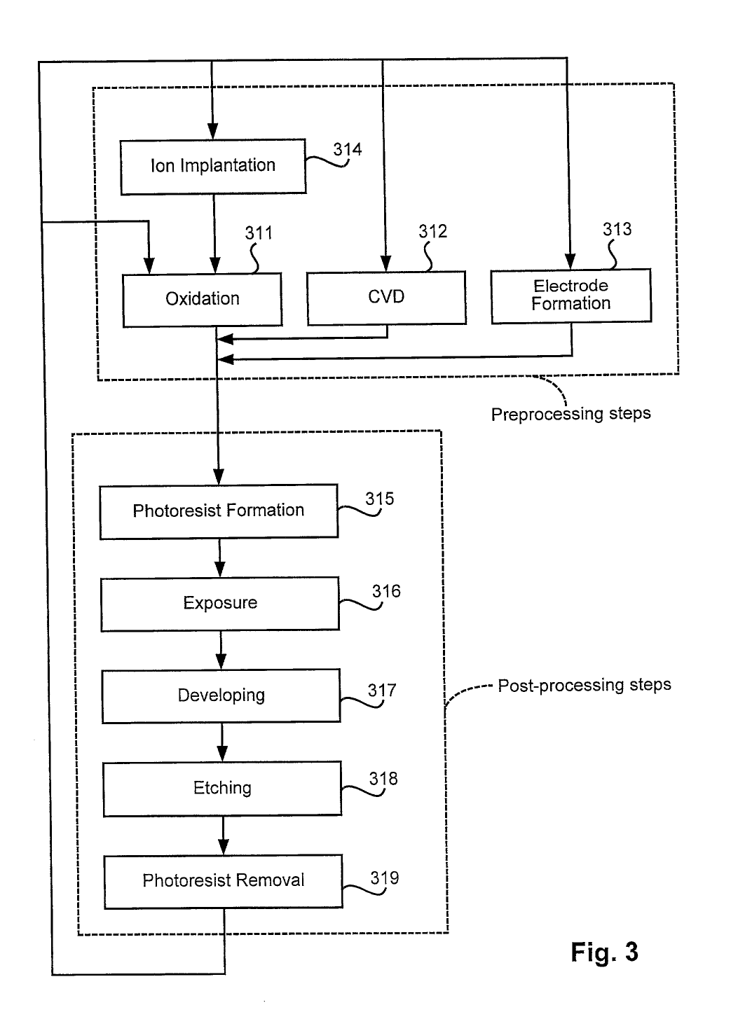

FIG. 3 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these preprocessing and post-processing steps.

It should be appreciated that various embodiments of the present invention described referring to FIGS. 4-20 may be utilized and/or incorporated with apparatus and methods described referring to FIGS. 1-3.

Although only a few embodiments of the present invention have been described in detail, it should be understood that the present invention may be embodied in many other specific forms without departing from the spirit or scope of the invention. Therefore, it should be apparent that the above described embodiments are to be considered as illustrative and not restrictive, and the invention is not to be limited to the details given herein, but may be modified within the scope of the appended claims.

What is claimed is:

1. An apparatus for providing support between a first structure and a second structure, comprising:
a supporting member mounted to the first structure and second structure, the supporting member having positive stiffness with respect to a direction that differs from a support direction of the apparatus;
a first section having at least one magnetic member, the first section being coupled to the first structure; and
a second section having at least one magnetic member, the second section being coupled to the second structure; wherein
the first and second sections present negative stiffness caused by magnetic force, thereby canceling at least a part of the positive stiffness of the supporting member.

2. The apparatus of claim 1, wherein the supporting member has a bellow that includes an airtight cavity, and the airtight cavity is pressurized.

3. The apparatus of claim 2, wherein the first and second sections are mounted within the cavity of the bellow.

4. The apparatus of claim 3, further comprising a pressurizing mechanism that controls pressure within the cavity of the bellow.

5. The apparatus of claim 2, wherein
the first section has a first cylindrical magnetic member,
the second section has a second cylindrical magnetic member, and
the first and second cylindrical magnetic members face with each other at an end thereof at the neutral position.

6. The apparatus of claim 5, wherein each of the first and second cylindrical magnetic members includes a retentive magnetic material.

7. The apparatus of claim 2, wherein
the first section has a first cylindrical magnetic member,
the second section has a second cylindrical magnetic member, and
the first cylindrical magnetic member is provided within the second cylindrical magnetic member.

8. The apparatus of claim 7, wherein each of the first and second cylindrical magnetic members includes a retentive magnetic material.

9. The apparatus of claim 7, wherein the first cylindrical magnetic member includes a retentive magnetic material, and the second cylindrical magnetic member includes a non-retentive magnetic material.

10. The apparatus of claim 2, wherein
the first section has a first cylindrical magnetic member,
the second section has second and third cylindrical magnetic members, and
the first cylindrical magnetic member is provided within the second and third cylindrical magnetic members.

11. The apparatus of claim 10, wherein the first cylindrical magnetic member includes a retentive magnetic material, and each of the second and third cylindrical magnetic members includes a non-retentive magnetic material.

12. The apparatus of claim 2, wherein
the first section has a first cylindrical magnetic member,
the second section has second, third, fourth and fifth cylindrical magnetic members, and
the first cylindrical magnetic member is provided within the second, third, fourth and fifth cylindrical magnetic members.

13. The apparatus of claim 12, wherein
each of the first, second and third cylindrical magnetic members includes a retentive magnetic material,
the first, second and third cylindrical magnetic members have a first, second and third direction of magnetic poles, respectively,
the first, second and third direction of magnetic poles are the same, and
each of the fourth and fifth cylindrical magnetic members includes a non-retentive magnetic material.

14. A method of providing support between a first structure and a second structure, comprising:
providing a supporting member mounted to the first structure and second structure, the supporting member having positive stiffness with respect to a direction that differs from a support direction of the apparatus;
coupling a first section to the first structure, the first section has at least one magnetic member; and
coupling a second section to the second structure, the second section has at least one magnetic member; wherein
the first and second sections present negative stiffness caused by magnetic force, thereby canceling at least a part of the positive stiffness of the supporting member.

15. The method of claim 14, wherein the supporting member has a bellow that includes an airtight cavity, and the airtight cavity is pressurized.

16. The method of claim 15, wherein the first and second sections are mounted within the cavity of the bellow.

17. The method of claim 16, further comprising a pressurizing mechanism for controlling pressure within the cavity of the bellow.

18. The method of claim 15, wherein
the first section has a first cylindrical magnetic member,
the second section has a second cylindrical magnetic member, and
the first and second cylindrical magnetic members face with each other at an end thereof at the neutral position.

19. The method of claim 18, wherein each of the first and second cylindrical magnetic members includes a retentive magnetic material.

20. The method of claim 15, wherein
the first section has a first cylindrical magnetic member,
the second section has a second cylindrical magnetic member, and
the first cylindrical magnetic member is provided within the second cylindrical magnetic member.

21. The method of claim 20, wherein each of the first and second cylindrical magnetic members includes a retentive magnetic material.

22. The method of claim 20, wherein the first cylindrical magnetic member includes a retentive magnetic material, and the second cylindrical magnetic member includes a non-retentive magnetic material.

23. The method of claim 15, wherein
the first section has a first cylindrical magnetic member,
the second section has second and third cylindrical magnetic members, and
the first cylindrical magnetic member is provided within the second and third cylindrical magnetic members.

24. The method of claim 23, wherein the first cylindrical magnetic member includes a retentive magnetic material, and each of the second and third cylindrical magnetic members includes a non-retentive magnetic material.

25. The method of claim 15, wherein
the first section has a first cylindrical magnetic member,
the second section has second, third, fourth and fifth cylindrical magnetic members, and
the first cylindrical magnetic member is provided within the second, third, fourth and fifth cylindrical magnetic members.

26. The method of claim 25, wherein
each of the first, second and third cylindrical magnetic members includes a retentive magnetic material,
the first, second and third cylindrical magnetic members have a first, second and third direction of magnetic poles, respectively,
the first, second and third direction of magnetic poles are the same, and
each of the fourth and fifth cylindrical magnetic members includes a non-retentive magnetic material.

27. A method for making an object using a lithography process, wherein the lithography process utilizes the supporting method of claim 14.

28. A method for patterning a wafer using a lithography process, wherein the lithography process utilizes the supporting method of claim 14.

29. A lithography system comprising:
an illumination system that irradiates radiant energy;
a positioning apparatus that disposes a substrate on a path of the radiant energy; and
a system that provides support between a first structure and a second structure, the system including,
a supporting member mounted to the first structure and second structure, the supporting member having positive stiffness with respect to a first direction;
a first section having at least one magnetic member, the first section being coupled to the first structure; and
a second section having at least one magnetic member, the second section being coupled to the second structure; wherein
the first and second sections present negative stiffness caused by magnetic force, thereby canceling at least a part of the positive stiffness of the supporting member.

30. The lithography system of claim 29, further comprising at least one actuator, wherein a driving force of the actuator and a support force generated by the system lie on substantially the same axis.

31. The lithography system of claim 30, wherein the support force generated by the system is substantially perpendicular to the first direction.

32. An object manufactured with the lithography system of claim 29.

33. A wafer on which an image has been formed by the lithography system of claim 29.
